(19) United States
(12) Patent Application Publication
(10) Pub. No.: US 2006/0035106 A1
(43) Pub. Date: Feb. 16, 2006

(54) Aluminum alloy sheet for high-speed high-temperature blow forming

(75) Inventors: Osamu Noguchi, Tokyo (JP); Toshiyasu Ukena, Tokyo (JP); Hitoshi Kazama, Saitama (JP); Kunihiro Yasunaga, Saitama (JP); Osamu Yokoyama, Tochigi (JP); Keiichiro Nakao, Tochigi (JP)

Correspondence Address: OPPENHEIMER WOLFF & DONNELLY LLP, 45 SOUTH SEVENTH STREET, SUITE 3300, MINNEAPOLIS, MN, 55402, US

(73) Assignees: Furukawa-Sky Aluminum Corp., Tokyo (JP); Honda Motor Co., Ltd., Tokyo (JP)

(21) Appl. No.: 11/195,148

(22) Filed: Aug. 2, 2005

(30) Foreign Application Priority Data
Dec. 13, 2004 (JP) 2004-359909
Aug. 3, 2004 (JP) 2004-226380

(51) Int. Cl. B32B 15/01

(52) U.S. Cl. 428/650

(57) ABSTRACT

An aluminum alloy sheet for high-speed high-temperature blow forming has an aluminum alloy containing 4 to 5% of Mg, 0.35 to 0.5% of Mn and 0.001 to 0.05% of Cr, 0.6% or less of Si+Fe, 0.15% or less of Cu, and the balance being substantially Al. The aluminum alloy sheet has an elongation of 150% or more in a high-temperature tensile test at 400 to 550° C. and at a strain rate of 10⁻²/second or more, has a cavitation area percentage of 2% or less at the time of 100% tensile deformation, and is free from any abnormally grown grains of 100 microns or more. A formed piece of the aluminum alloy sheet also has a cavitation area percentage of 2% or less when blow-formed at 400 to 550° C. and at a reduction in sheet thickness of 65% or less, and is free from any abnormally grown grains of 100 microns or more.

### BACKGROUND OF THE INVENTION

1. Field of the Invention

This invention relates to an aluminum alloy sheet for high-speed high-temperature blow forming, which is used in automobile component parts and the like.

2. Description of Related Art

As forming sheet materials for automobile component parts, cold-rolled steel sheets have often been used in the past. In recent years, however, aluminum alloy sheets have come into wide use as the forming sheet materials for automobile component parts, for the purpose of, e.g., making automobile component parts light-weight to improve mileage of automobiles and also to lessen the quantity of carbon dioxide to be discharged, in order to prevent global warming.

However, aluminum alloys usually have a stamping form-ability inferior to that of cold-rolled steel sheets. Where an aluminum alloy sheet is stamping-formed to produce an automobile component part, methods must be employed, e.g., a method in which the whole component part is not integrally formed, but is dividedly formed followed by joining, and a method in which multi-stepwise stamping forming is used. Thus, under actual circumstances, these methods have caused a rise in cost.

Now, as one of processes for forming aluminum alloy sheets, a high-temperature blow forming process is conventionally known in the art. This high-temperature blow forming process is a process in which an aluminum alloy base sheet is placed in a die or tool in the state it has been heated to a temperature range where the aluminum alloy gains its ductility, and then a gas pressure is introduced into the tool to press the aluminum alloy base sheet against the inner face of the tool to form the same. In general, such a high-temperature blow forming process usually makes use of an aluminum alloy capable of exhibiting in a high-temperature range what is called superplasticity (an aluminum-base super-plastic alloy) as exemplified by 7475 alloy or 5083 alloy, and is carried out in a temperature range where such an alloy exhibits a large superplastic elongation of hundreds of percents (%) or more. Such high-temperature blow forming making use of the superplastic alloy enables forming at a high strain or in a complex shape. It also has an advantage that the cost required for tools can be reduced because, as being different from usual stamping forming, the forming can be carried out using only a one-side tool.

As aluminum-base superplastic alloy sheets suited for the high-temperature blow forming as stated above, those disclosed in Japanese Patent Applications Laid-open No. H7-197177, No. S59-159961, No. H10-259441 and No. 2002-11527 have already been proposed.

For example, an aluminum alloy rolled sheet for super-plastic forming which is disclosed in the publication Japanese Patent Application Laid-open No. H7-197177 is described as being able to achieve a high-temperature tensile elongation of 300% or more by compositional control of components, which is an elongation greatly superior to the elongation the cold-rolled steel sheet has. However, as a suitable forming condition, a low strain rate of 10⁻³/sec or less is set out, and hence this requires a long time of as much as 10 minutes to 100 minutes for the forming. Accordingly, this aluminum alloy rolled sheet has a problem that it is not easily adaptable to mass production as in automobile component parts.

The publications Japanese Patent Applications Laid-open No. S59-159961 and No. H10-259441 also disclose that the addition of Cu or the like as an alloy component brings out a superior superplastic performance. However, the Cu is an element which greatly lowers corrosion resistance of materials, and hence is not readily applicable to uses where a severe corrosion resistance is required as in the automobile component parts. Further, in the publication Japanese Patent Application Laid-open No. 2002-11527, proposed is a 5083 alloy intended for high-speed forming. However, high Mn or Cr type materials like the 5083 alloy have a great resistance to deformation of materials, and hence this requires a long forming time, resulting in a low productivity. Thus, such an alloy is unsuitable for the mass production as in automobile component parts.

Now, in the conventional superplastic alloys as stated above, researches are commonly set forward in the direction of improvement in productivity by making forming speed higher. As a result of experiments and studies made repeatedly by the present inventors, however, it has been found that crystal grains become abnormally coarse over the whole areas, or in local areas, of a formed piece in a case in which the strain rate at the time of forming (i.e., the forming speed) is made simply higher. It has turned out that, in this case, the crystal grains may abnormally grow to have a size of hundreds of micrometers (μm), or in some cases a size that is in units of millimeters (mm), and hence this brings about a very serious problem in respect of the strength and external appearance of formed pieces. Nonetheless, in the past, there has been no understanding at all as to the phenomenon that the crystal grains become abnormally coarse as stated above. Hence, as a matter of course, it is the actual state that in the related art there has been no preventive measure against such a phenomenon. Thus, it must be said that the related art in which no preventive measure has been taken on the phenomenon that the crystal grains become abnormally coarse has involved techniques that are still not sufficient enough and not complete enough to be applicable to the uses where the strength and external appearance are severely required as in the automobile component parts.

As discussed above, the superplastic alloy having a high-temperature tensile elongation of hundreds of percents (%) has the possibility that, if the forming speed is made higher in order to improve productivity, crystal grains become abnormally coarse during forming to damage the strength and external appearance of formed pieces.

Now, when used in the high-temperature blow forming for automobile component parts and the like, aluminum alloy sheets are required to have a sufficiently higher ductility than those for usual forming, but in many cases not required to have the ductility (superplasticity) that is as extremely high as hundreds of percents (%) in high-temperature tensile elongation. Stated specifically, they may in many cases be sufficient as long as they have a ductility of up to about 65% as reduction in sheet thickness.

Meanwhile, in the superplastic forming, cavitation (cavities) tends to occur at crystal grain boundaries, which comes from a deformation mechanism due to grain boundary sliding. The occurrence of such cavitation not only obstructs the ductility but also damages mechanical properties and fatigue strength of materials. Accordingly, in the superplastic alloy, it is essential to prevent the cavitation from occurring. However, even in the case of the aluminum alloy sheet which has a higher ductility than the superplastic alloy and is about 65% or less as reduction in sheet thickness, it is considered that there is a possibility of the occurrence of cavitation at the time of high-temperature blow forming carried out at a high forming speed.

### SUMMARY OF THE INVENTION

The present invention has been made taking account of the above circumstances as the background. Accordingly, an object of the present invention is to provide an aluminum alloy sheet for high-speed high-temperature blow forming, which can be kept from the abnormal growth of crystal grains during the forming and also may less cause the cavitation, in high-temperature blow forming for automobile component parts which are not required to have so high a ductility as the superplastic aluminum alloy sheets each proposed as stated above, in particular, high-temperature blow forming carried out at a high strain rate.

The present inventors have repeated various experiments and studies in order to solve the problems discussed above. As the result, they have discovered that the composition of alloy components may be controlled within a suitable range, whereby, even where the high-temperature blow forming is carried out at a high strain rate that has not been set in the past, no abnormal growth of crystal grains may take place and also the occurrence of cavitation can be kept minimum. Thus, they have accomplished the present invention.

Stated specifically, as a first embodiment, the aluminum alloy sheet for high-speed high-temperature blow forming of the present invention is an aluminum alloy sheet which comprises an aluminum alloy containing from 4% to 5% (mass %; the same applies hereinafter) of Mg, from 0.35% to 0.5% of Mn and from 0.001% to 0.05% of Cr, and having Si and Fe which have been regulated to be 0.6% or less in total weight and a Cu content regulated to be 0.15% or less, and the balance being composed of Al and unavoidable impurities; and is used for high-speed high-temperature blow forming carried out at a temperature within the range of from 400° C. or more to 550° C. or less and at a working degree of 65% or less as reduction in sheet thickness;

the aluminum alloy sheet having an elongation of 150% or more where high-temperature tensile deformation is applied at a temperature within the range of from 400° C. or more to 550° C. or less and at a strain rate of 10⁻²/sec or more, having a cavitation area percentage of 2% or less at the time of 100% tensile deformation in the high-temperature tensile deformation, and further being free from any abnormal grain growth to 100 microns or more in grain diameter at the time of the high-temperature tensile deformation.

In a second embodiment, the aluminum alloy sheet for high-speed high-temperature blow forming of the present invention is an aluminum alloy sheet which comprises an aluminum alloy containing from 4% to 5% of Mg, from 0.35% to 0.5% of Mn and from 0.001% to 0.05% of Cr, and having Si and Fe which have been regulated to be 0.6% or less in total weight and a Cu content regulated to be 0.15% or less, and the balance being composed of Al and unavoidable impurities; and is used for high-speed high-temperature blow forming carried out at a temperature within the range of from 400° C. or more to 550° C. or less and at a working degree of 65% or less as reduction in sheet thickness; the aluminum alloy sheet having a cavitation area percentage of 2% or less as a product having been put to the high-speed high-temperature blow forming, and being free from any abnormal grain growth to 100 microns or more in grain diameter during the high-speed high-temperature blow forming.

According to the aluminum alloy sheet for high-speed high-temperature blow forming of the present invention, even when high-temperature blow forming is carried out at a high strain rate, no abnormal growth of crystal grains may take place during the forming, and also the cavitation may less occur, and therefore component parts with superior external-appearance characteristics, static strength and fatigue characteristics can be obtained when used in the high-temperature blow forming for automobile component parts and the like.

### BRIEF DESCRIPTION OF THE DRAWINGS

FIG. 1 is an alloy texture photograph (magnifications: 100 times) for describing abnormal growth of crystal grains at the time of high-temperature blow forming.

FIG. 2 is a schematic view showing a tool for blow forming, used in Example 3.

FIG. 3 is a schematic view showing a fatigue test piece picked in Example 4.

### DESCRIPTION OF THE PREFERRED EMBODIMENTS

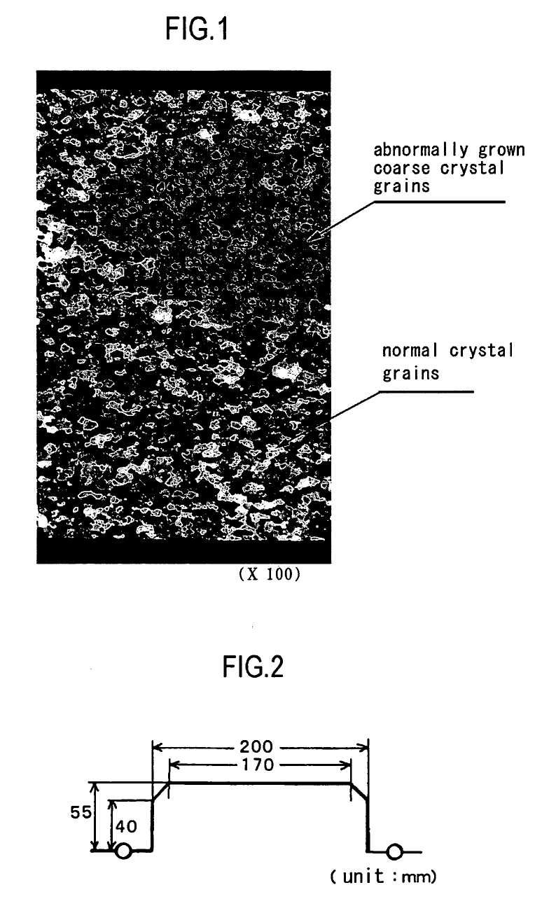

As a result of repeated various experiments and studies on the high-temperature blow forming having a high strain rate at the time of the forming, the present inventors have discovered that the phenomenon in which crystal grains become abnormally coarse during the high-temperature blow forming is a phenomenon which differs from the grain growth that takes place under forming conditions where the forming is carried out for a long time, in respect of conventional commonly available superplastic alloys. Here, a sectional texture photograph of crystal grains having abnormally grown at the time of high-temperature blow forming is shown in FIG. 1.

The texture shown in FIG. 1 is one in which the abnormal grain growth has locally taken place. The crystal grains thus grown abnormally are 350 μm or more in diameter, and stand coarse crystal grains having a size of not less than as many as 10 times that of normal crystal grains. Then, it has been confirmed that such abnormal grain growth does not takes place where the blow forming is not carried out and only heat is applied. Then, from such a finding, the present inventors have perceived that the prevention of the abnormal growth of crystal grains is an important point in order to carry out the high-temperature blow forming in a short time that has ever been unachievable. Based on such perception, they have made studies on the optimum range of alloy elements that does not cause any abnormal growth of crystal grains during such short-time high-temperature blow forming, and on the mechanism thereof, where they have accomplished the present invention. Incidentally, here, the strength and external appearance of formed pieces are not so much damaged as long as crystal grains having grown are less than 100 μm in diameter. Hence, in the present invention, a case in which crystal grains have grown to have diameters of 100 μm or more is defined to be called “abnormal growth”.

In the present invention, as aluminum alloy component composition, the aluminum alloy sheet for high-speed high-temperature blow forming especially contains from 4% to 5% of Mg, from 0.35% to 0.5% of Mn and from 0.001% to 0.05% of Cr, and has Si and Fe which have been regulated to be 0.6% or less in total weight (Si+Fe) and a Cu content regulated to be 0.15% or less, and the balance being composed of Al and unavoidable impurities. Such compositional selection enables prevention of the abnormal growth of crystal grains during the high-speed high-temperature blow forming carried out at a high strain rate and also enables the cavitation to less occur, as so discovered.

The reason why the aluminum alloy component composition is limited to the above is explained below.

Mg:

The Mg is an element that governs the ductility at high temperature in the aluminum alloy sheet, and at the same time an element that is also effective in providing the product sheet with strength at normal temperature. If the Mg is in a content of less than 4%, no sufficient ductility may be achieved at the time of the high-speed high-temperature blow forming, and also an insufficient normal-temperature strength may result. If on the other hand the Mg is in a content of more than 5%, the alloy may have low rolling properties (rollability), in particular, in hot rolling, and may remarkably cause break during the hot rolling, therefore resulting in a low material yield to make the material unsuitable for uses where importance is attached to cost as in materials for automobiles. Also, if the Mg is in a content of more than 5%, the alloy sheet may have a high resistance to deformation at the time of the high-speed high-temperature blow forming to make the forming time longer, resulting in a low productivity. Accordingly, the Mg content is so designed as to be regulated within the range of from 4% to 5%.

Mn:

The Mn is an element that stabilizes crystal grains at the time of heat treatment at high temperature and at the time of the high-speed high-temperature blow forming. If the Mn is in a content of less than 0.35%, the effect of stabilizing crystal grains as stated above may be so insufficient as to make crystal grains coarse at the time of heat treatment or at the time of the high-speed high-temperature blow forming, so that the material may be hindered from its uniform deformation and also the product obtained may have a poor external appearance, further resulting in low static strength and fatigue strength at normal temperature. If on the other hand the Mn is in a content of more than 0.5%, not only the alloy sheet may have a high resistance to deformation at the time of the high-speed high-temperature blow forming to make the forming time longer, resulting in a low productivity, but also the action to partially restrain recrystallization due to strain introduced during deformation at a high strain rate may come higher, and this may inevitably accelerate the abnormal grain growth. Accordingly, the Mn content is so designed as to be regulated within the range of from 0.35% to 0.5%.

Cr:

The Cr is, like the Mn, an element that stabilizes crystal grains at the time of heat treatment at high temperature and at the time of the high-speed high-temperature blow forming. If the Cr is in a content of less than 0.001%, such an effect of stabilizing crystal grains may be so insufficient as to make crystal grains coarse at the time of heat treatment or at the time of the high-speed high-temperature blow forming, so that the material may be hindered from its uniform deformation and also the product obtained may have a poor external appearance, further resulting in low static strength and fatigue strength at normal temperature. If on the other hand the Cr is in a content of more than 0.05%, not only the alloy sheet may have a high resistance to deformation at the time of the high-speed high-temperature blow forming to make the forming time longer, resulting in a low productivity, but also the action to partially restrain recrystallization due to strain introduced during deformation at a high strain rate may come higher, and this may inevitably accelerate the abnormal grain growth. Accordingly, the Cr content is so designed as to be regulated within the range of from 0.001% to 0.05%.

Si+Fe:

If the Si and Fe are in a content of more than 0.6% in total weight, an Al—Fe—Si type intermetallic compound may be produced in a large quantity to make the cavitation occur greatly as a result of the forming. Accordingly, the Si+Fe content is so designed as to be regulated at 0.6% or less.

Cu:

The Cu is an element that improves strength at normal temperature, but at the same time lowers corrosion resistance extremely. In particular, where the formed pieces are left to cool after the forming as in the case of the high-speed high-temperature blow forming, the Cu may coarsely precipitate at crystal grain boundaries during the cooling to inevitably lower grain boundary corrosion resistance or anti-filiform corrosion. Such a phenomenon especially tends to occur when the Cu content is more than 0.15%. Accordingly, the Cu content is so designed as to be regulated at 0.15% or less.

The balance with respect to the foregoing respective alloy elements may basically be Al and unavoidable impurities. Note, however, that, in usual aluminum alloys, Ti is often added when the aluminum alloys are casted, in order to make casting alloys have fine crystal grains. In this case, the Ti is commonly added in the form of Al—Ti, Al—Ti—B or Al—Ti—C, as usual cases. In the case of the present invention as well, the Ti may be added in an amount of from 0.001% to 0.1%, which is a range commonly available. Also, simultaneously with the addition of Ti, one or both of B and C may be added in an amount of from 0.0001% to 0.05%. In Al—Mg alloys, Be is also added in some cases in order to prevent surface oxidation. In the case of the present invention as well, Be may be added in an amount of from 0.0001% to 0.01%, where there can be no particular difficulties.

The aluminum alloy sheet for high-speed high-temperature blow forming of the present invention as described above is, as will be described later again, put to high-speed high-temperature blow forming at a temperature within the range of from 400 to 550° C. and at a reduction in sheet thickness of 65% or less. Also, in order to carry out the high-speed high-temperature blow forming in a short time, it is desirable for the blow forming to be carried out at the speed of a strain rate of 10⁻²/sec or more. In the aluminum alloy sheet for high-speed high-temperature blow forming of the present invention, no abnormal grain growth may take place during the forming even in the high-speed high-temperature blow forming carried out in a short time at such a high strain rate, and also the occurrence of cavitation can be kept minimum.

Here, the high-temperature formability of the aluminum alloy sheet, the abnormal grain growth at the time of the high-speed high-temperature blow forming and the occurrence of cavitation can be evaluated by a high-temperature tensile test. Accordingly, in the invention according to the first embodiment, the performance of the aluminum alloy sheet for high-speed high-temperature blow forming is evaluated by test results obtained in a high-temperature tensile test conducted at temperatures within the range of from 400 to 550° C. Stated specifically, it has been defined that the aluminum alloy sheet has an elongation of 150% or more where high-temperature tensile deformation is applied at a temperature within the range of from 400° C. or more to 550° C. or less and at a strain rate of 10⁻²/sec or more, has a cavitation area percentage of 2% or less at the time of 100% tensile deformation in the high-temperature tensile deformation, and further is free from any abnormal grain growth of 100 microns or more in grain diameter at the time of the high-temperature tensile deformation.

Evaluation items at the time of specific high-speed high-temperature blow forming have also been defined in the invention according to the second embodiment. Stated specifically, it has been defined that the aluminum alloy sheet has a cavitation area percentage of 2% or less as a product having been put to the high-speed high-temperature blow forming at a temperature within the range of from 400° C. or more to 550° C. or less and at 65% or less as reduction in sheet thickness, and is free from any abnormal grain growth to 100 microns or more in grain diameter during the high-speed high-temperature blow forming.

There are no particular limitations on how to produce the aluminum alloy sheet for high-speed high-temperature blow forming of the present invention. It is preferable to use the following method.

That is, after DC (direct chill) casting, the casting alloy obtained is subjected to homogenizing treatment at a temperature within the range of from 450° C. to 550° C., then put to rolling of 98% or more by hot rolling, and subsequently put to rolling of 50% or more by cold rolling. Here, intermediate annealing for improving rollability may be carried out after the cold rolling or in the middle of the cold rolling. After the cold rolling has been completed, the rolled sheet obtained may be put to the high-speed high-temperature blow forming as it has stood cold-rolled, or annealing as recrystallization heat treatment may be carried out before the high-speed high-temperature blow forming. Methods for the annealing in this case may include, but are not particularly limited to, electromagnetic heating, electrification heating, infrared heating, hot-air heating, and heating in contact with a high-temperature object. In order to make initial recrystallized grains finely uniform, it is preferable to apply rapid heating of 5° C./second or more.

In actually carrying out the high-speed high-temperature blow forming on the aluminum alloy sheet for high-speed high-temperature blow forming of the present invention, as stated above, the blow forming temperature is set within the range of from 400 to 550° C. and also the working degree as a result of the blow forming is set at 65% or less. Also, the strain rate in that high-speed high-temperature blow forming may preferably be set at 10⁻²/sec or more.

These conditions for high-speed high-temperature blow forming are described next.

First, if the forming temperature in the high-speed high-temperature blow forming is less than 400° C., the material may have a high resistance to deformation and also may have a low ductility, and hence this makes it difficulty to carry out high-speed blow forming. If on the other hand the forming temperature is more than 550° C., the material may locally liquefy, and hence the cavitation may greatly occur. In an extreme case, there is a possibility that the aluminum alloy sheet bursts during the blow forming, and further the local abnormal grain growth may be accelerated. Accordingly, the blow forming temperature is set within the range of from 400 to 550° C.

The working degree of the high-speed high-temperature blow forming is also set at 65% or less as reduction in sheet thickness. If the reduction in sheet thickness is more than 65%, there is a possibility that the aluminum alloy sheet locally bursts to come unformable. In the present invention, the forming at a reduction in sheet thickness of hundreds of percents (%) as in what is called the superplastic forming is not intended, and the forming at the reduction in sheet thickness of up to 65% is sufficient in the forming for usual automobile component parts or so. On the other hand, in the blow forming for usual automobile component parts, usually desirable is a working degree of 40% or more as reduction in sheet thickness, where, the larger the deformation level is, the more greatly the cavitation may also occur. Accordingly, as an index of the cavitation, the cavitation area percentage at the time of the high-speed high-temperature blow forming carried out at the reduction in sheet thickness of 65% or less is so designed as to be controlled at 2% or less as stated previously. If the cavitation area percentage is more than 2%, such an aluminum alloy sheet may greatly deteriorate post-forming characteristics, e.g., static strength and fatigue characteristics.

In addition, as to the strain rate in the high-speed high-temperature blow forming, if it is less than 10⁻²/sec, the effect of shortening the forming time to improve productivity is not obtainable, compared with the forming which makes use of conventional superplastic alloys. Hence, in order to achieve the intended objects, it is preferable to carry out the high-speed high-temperature blow forming at a high speed of a strain rate of 10⁻²/sec or more.

### EXAMPLES

Examples of the present invention are given below together with Comparative Examples. Incidentally, the following Examples are nothing more than those which demonstrate the effect of the present invention, and of course the conditions set out in each Example are by no means those which limit the scope of the present invention.

### Example 1

As to alloys which were composed as shown by alloy symbols a to h in Table 1, they were made into ingots by a conventional method, which were then put to DC casting. The DC castings of 550 mm in thickness thus obtained were subjected to homogenizing treatment at 480° C. Thereafter, these were each put to hot rolling of 99% in rolling percentage, and then put to cold rolling (cold rolling percentage: 70%) to have a sheet thickness of 1.5 mm. After the cold rolling, as to some materials (materials corresponding to Test Nos. 13 to 15 in Table 2 and Forming Nos. 13 to 15 in Table 3), they were thereafter not subjected to recrystallization heat treatment as they had stood cold-rolled. As to the remaining materials (materials corresponding to Test Nos. 1 to 12 in Table 2 and Forming Nos. 1 to 12 in Table 3), they were subjected to recrystallization heat treatment through a 500° C. continuous annealing line (heating rate: 15° C./second).

From the aluminum alloy sheets (product sheets) thus obtained, tensile test pieces (gage length: 15 mm) were cut out, and high-temperature tensile tests were conducted according to JIS H 7501, at various temperatures and various strain rates to examine elongation and also examine cavitation area percentage at 100% elongation. Results obtained are shown in Table 2.

TABLE 1

| Alloy | | | | | | | | |
|---|---|---|---|---|---|---|---|---|
| sym- | Component composition (mass %) | | | | | | | |
| bol | Mg | Mn | Cr | Fe | Si | Cu | Al | Class |
| a | 4.39 | 0.37 | 0.01 | 0.27 | 0.19 | 0.01 | Bal. | Invtn. |
| b | 4.65 | 0.22 | 0.01 | 0.29 | 0.22 | 0.00 | Bal. | Cp. |
| c | 4.78 | 0.68 | 0.04 | 0.21 | 0.16 | 0.02 | Bal. | Cp. |
| d | 4.53 | 0.45 | 0.08 | 0.25 | 0.23 | 0.01 | Bal. | Cp. |
| e | 4.61 | 0.42 | 0.01 | 0.47 | 0.28 | 0.01 | Bal. | Cp. |
| f | 4.26 | 0.35 | 0.01 | 0.25 | 0.21 | 0.16 | Bal. | Cp. |
| g | 3.62 | 0.41 | 0.01 | 0.22 | 0.18 | 0.02 | Bal. | Cp. |
| h | 5.57 | 0.46 | 0.01 | 0.18 | 0.14 | 0.01 | Bal. | Cp. |

Invtn.: Example of the invention
Cp.: Comparative Example

TABLE 2

| | | Tensile test | | | |
|---|---|---|---|---|---|
| | | conditions | | Results | |
| | Alloy | | Strain | Elon- | Cavitation |
| Test | sym- | Temp. | rate | gation | area percentage |
| No. | bol | (° C.) | (/sec) | (%) | (%) |
| 1 | a | 520 | 5 × 10⁻² | 280 | 0.7 |
| 2 | a | 480 | 1 × 10⁻² | 200 | 0.8 |
| 3 | a | 480 | 1 × 10⁻¹ | 160 | 0.9 |
| 4 | a | 390 | 1 × 10⁻² | 110 | 1.7 |
| 5 | a | 560 | 1 × 10⁻² | 240 | 2.5 |
| 6 | b | 480 | 1 × 10⁻² | 120 | 1.6 |
| 7 | c | 480 | 1 × 10⁻² | 240 | 0.8 |
| 8 | d | 480 | 1 × 10⁻² | 230 | 0.9 |
| 9 | e | 480 | 1 × 10⁻² | 110 | 3.4 |
| 10 | f | 480 | 1 × 10⁻² | 290 | 1.4 |
| 11 | g | 480 | 1 × 10⁻² | 130 | 1.6 |
| 12 | h | 480 | 1 × 10⁻² | 220 | 0.8 |
| 13 | a | 520 | 5 × 10⁻² | 270 | 0.8 |
| 14 | a | 480 | 1 × 10⁻² | 210 | 0.7 |
| 15 | a | 480 | 1 × 10⁻¹ | 160 | 0.8 |

As shown in Table 2, in Alloy a, which is within the component compositional range of the present invention, a high elongation was achieved at a high-rate tensile of 1×10⁻²/second, 5×10⁻²/second and even at 1×10⁻¹/second where the tensile tests were conducted at temperatures within the range of from 400 to 550° C. (Test Nos. 1 to 3 and 13 to 15). In contrast thereto, even Alloy a, falling in the scope of the present invention, showed a low elongation where the tensile temperature was lower than 400° C. (Test No. 4), and, where on the other hand the tensile temperature was higher than 550° C. (Test No. 5), showed a high elongation but resulted in a larger cavitation area percentage. Meanwhile, materials showed a low elongation also where the Mn content or the Mg content was small (Alloys b and g) and where the Fe+Si content was large (Alloy e). Incidentally, where the Mn content or the Cr content, Cu content or Mg content is large (Alloys c, d, f and h), none of them were seen to be especially inferior in the elongation and cavitation area percentage at the time of the tensile test.

### Example 2

Blow forming test pieces (squares of 200 mm in each side) were respectively cut out from the materials obtained in Example 1, and the high-speed high-temperature blow forming was carried out using a tool of 100 mm in diameter, heated to 480° C. To evaluate blow formability, the minimum sheet thickness at rupture was measured to calculate the reduction in sheet thickness. Also, crystal grains of formed pieces were ascertained by aqua regia etching to observe macrostructures of the surfaces and partly make microscopic observation of the sections. Further, cavitation area percentage at rupture was examined by a conventional method (the area method). Results obtained are shown in Table 3.

TABLE 3

| | | | | Results | | |
|---|---|---|---|---|---|---|
| | | | | | Cavita- | |
| | | | | | tion | |
| | Al- | Blow forming | | Reduction | area | Ab- |
| Form- | loy | conditions | | in sheet | per- | normal |
| ing | sym- | Time | Temp. | thickness | centage | grain |
| No. | bol | (min) | (° C.) | (%) | (%) | growth |
| 1 | a | 20 | 480 | 62 | 1.8 | No |
| 2 | a | 10 | 480 | 58 | 1.6 | No |
| 3 | a | 4 | 480 | 49 | 1.9 | No |
| 4 | a | 10 | 390 | 30 | 1.5 | No |
| 5 | a | 10 | 560 | 56 | 4.2 | No |
| 6 | b | 10 | 480 | 38 | 1.8 | Yes |
| 7 | c | 10 | 480 | 55 | 1.5 | Yes |
| 8 | d | 10 | 480 | 60 | 1.6 | Yes |
| 9 | e | 10 | 480 | 30 | 3.8 | No |
| 10 | f | 10 | 480 | 59 | 1.6 | No |
| 11 | g | 10 | 480 | 34 | 2.1 | No |
| 12 | h | 10 | 480 | 37 | 1.6 | No |
| 13 | a | 20 | 480 | 60 | 1.7 | No |
| 14 | a | 10 | 480 | 57 | 1.7 | No |
| 15 | a | 4 | 480 | 51 | 1.6 | No |

As shown in Table 3, where the test pieces of Alloy a, which is within the component compositional range of the present invention, were put to the blow forming at temperatures within the range of from 400 to 550° C. (Test Nos. 1 to 3 and 13 to 15), the reduction in sheet thickness at rupture was larger with time of forming, but a sufficient reduction in sheet thickness was achievable even by the blow forming carried out for only 4 minutes. Where on the other hand the blow forming temperature was low (Test No. 4), the rupture had taken place at a point in time where the reduction in sheet thickness was small. Also, where the blow forming temperature was too high (Test No. 5), although the reduction in sheet thickness was large, a very large cavitation area percentage resulted. Further, also where the Mn content or the Mg content was small (Alloys b and g) and where the Fe+Si content was large (Alloy e), the reduction in sheet thickness at rupture at the time of blow forming was not more than 40%. Thus, these were proved not to be endurable to the forming of component parts with complicate shape. Meanwhile, where the Mn content or the Cr content is too large (Alloys c and d), the blow formability was as good as the alloy of the present invention, but abnormal grain growth had locally taken place. Where the Mg content is too large (Alloy h), the deformation did not proceed because of a high deformation resistance, resulting in a low reduction in sheet thickness (incidentally, in the table, both the reduction in sheet thickness and the cavitation area percentage are shown as values measured in the state the sample came not into rupture because only the sample of Alloy h of Forming No. 12 did not ruptured under this condition). Where the Cu content was large (Alloy f), the blow formability was good, and also any abnormal grain growth did not take place.

### Example 3

As to the materials showing reduction in sheet thickness which was as good as 45% or more in Example 2 (Alloys a, c, d and f, all of which were those subjected to the recrystallization heat treatment after the cold rolling), female-tool blow forming was carried out using a tool having the shape shown in FIG. 2. Incidentally, the reduction in sheet thickness at the bottom flat portion after the blow forming was from 41% to 43%.

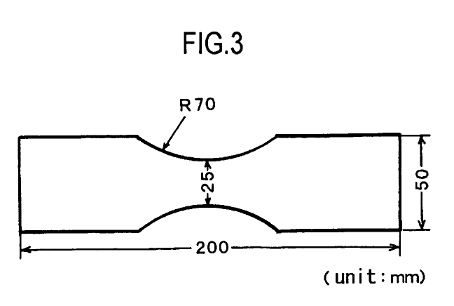

JIS No.13B tensile test pieces were picked from the formed pieces at their positions of bottom diagonals after the blow forming, and tensile tests were conducted according to JIS Z 2241 to measure normal-temperature mechanical properties after blow forming [TS: tensile strength (Mpa); YS: yield stress (Mpa); EL: elongation (%)]. Also, corrosion resistance evaluation samples were picked from the formed pieces at their bottoms to conduct a corrosion resistance test according to JIS Z 2371. In this corrosion resistance test, “for a day at 35° C. under salt spray (5% NaCl)—for 5 days in an environment of 40° C./85% RH—in-room leaving for a day in a room” was set as one cycle. After eight cycles, maximum filiform corrosion length (mm) was examined, where a maximum filiform corrosion length of 1.5 mm or less was judged to be good. To further examine fatigue characteristics, samples each having the shape shown in FIG. 3 were cut out from the formed pieces at their positions of bottom diagonals. An axial fatigue test was conducted at a frequency of 30 Hz according to JIS Z 2273, and stress applied in a number of cycles of 10⁷ times or more until rupture, i.e., fatigue strength (MPa) was measured. Results obtained on these are shown in Table 4.

TABLE 4

| | | Blow | | Results | | | | |
|---|---|---|---|---|---|---|---|---|
| | Al- | forming | | | | | Corro- | |
| Form- | loy | conditions | | | | | sion | Fatigue |
| ing | sym- | Time | Temp. | TS | YS | EL | resist- | strength |
| No. | bol | (min) | (° C.) | (MPa) | (MPa) | (%) | ance | (MPa) |
| 21 | a | 20 | 480 | 269 | 123 | 24 | A | 120 |
| 22 | a | 10 | 480 | 271 | 122 | 24 | A | 120 |
| 23 | a | 4 | 480 | 268 | 125 | 25 | A | 120 |
| 24 | a | 10 | 560 | 220 | 105 | 21 | A | 90 |
| 25 | c | 10 | 480 | 247 | 95 | 22 | A | 100 |
| 26 | d | 10 | 480 | 235 | 89 | 24 | A | 100 |
| 27 | f | 10 | 480 | 266 | 121 | 25 | C | 120 |
| 28 | 1* | — | — | 277 | 126 | 26 | A | 120 |

1*: Material sheet, A: Good. C: Poor

As shown in Table 4, where the test pieces of Alloy a of the present invention were put to the blow forming at temperatures within the range of from 400 to 550° C. (Forming Nos. 21 to 23), their normal-temperature mechanical properties after blow forming were substantially the same as those of material sheets having not been put to the blow forming. Where on the other hand the blow forming was carried out at a high temperature of 560° C. and the cavitation much occurred (Forming No. 24), the normal-temperature mechanical properties after blow forming deteriorated. Meanwhile, where the materials having large Mn content and Cr content (Alloys c and d) were used, the abnormal grain growth took place, and hence the normal-temperature mechanical properties after blow forming deteriorated. Also, as to the material having a large Cu content (Alloy f), it little changed in the normal-temperature mechanical properties after blow forming, but was inferior in corrosion resistance.

Further, as to the fatigue characteristics, the 10⁷-time fatigue strength was equal to that of the unformed material sheets where the blow forming was carried out at temperatures within the range of from 400 to 550° C. (Forming Nos. 21 to 23). However, where the blow forming was carried out at 560° C. and the cavitation much occurred (Forming No. 24), the sample showed a low 10⁷-time fatigue strength after blow forming. Where the materials having large Mn content and Cr content (Alloys c and d) were used, the abnormal grain growth took place, resulting in a lower 10⁷-time fatigue strength after blow forming.

1. An aluminum alloy sheet for high-speed high-temperature blow forming, which aluminum alloy sheet comprises an aluminum alloy containing from 4 mass % to 5 mass % of Mg, from 0.35 mass % to 0.5 mass % of Mn and from 0.001 mass % to 0.05 mass % of Cr, and having Si and Fe which have been regulated to be 0.6 mass % or less in total weight and a Cu content regulated to be 0.15 mass % or less, and the balance being composed of Al and unavoidable impurities; and is used for high-speed high-temperature blow forming carried out at a temperature within the range of from 400° C. or more to 550° C. or less and at a working degree of 65% or less as reduction in sheet thickness;
said aluminum alloy sheet having an elongation of 150% or more where high-temperature tensile deformation is applied at a temperature within the range of from 400° C. or more to 550° C. or less and at a strain rate of 10⁻²/second or more, having a cavitation area percentage of 2% or less at the time of 100% tensile deformation in the high-temperature tensile deformation, and further being free from any abnormal grain growth to 100 microns or more in grain diameter at the time of the high-temperature tensile deformation.

2. An aluminum alloy sheet for high-speed high-temperature blow forming, which aluminum alloy sheet comprises an aluminum alloy containing from 4 mass % to 5 mass % of Mg, from 0.35 mass % to 0.5 mass % of Mn and from 0.001 mass % to 0.05 mass % of Cr, and having Si and Fe which have been regulated to be 0.6 mass % or less in total weight and a Cu content regulated to be 0.15 mass % or less, and the balance being composed of Al and unavoidable impurities; and is used for high-speed high-temperature blow forming carried out at a temperature within the range of from 400° C. or more to 550° C. or less and at a working degree of 65% or less as reduction in sheet thickness;
said aluminum alloy sheet having a cavitation area percentage of 2% or less as a product having been put to said high-speed high-temperature blow forming, and being free from any abnormal grain growth to 100 microns or more in grain diameter during said high-speed high-temperature blow forming.

3. The aluminum alloy sheet according to claim 1, which has an elongation of from 160% or more to 280% or less where high-temperature tensile deformation is applied at a temperature within the range of from 480° C. or more to 520° C. or less and at a strain rate of from 1×10⁻²/second or more to 1×10⁻¹/second or less, and has a cavitation area percentage of from 0.7% or more to 0.9% or less at the time of 100% tensile deformation in the high-temperature tensile deformation.

4. The aluminum alloy sheet according to claim 1, which has a cavitation area percentage of from 1.6% or more to 1.9% or less as a product having been put to said high-speed high-temperature blow forming.

5. The aluminum alloy sheet according to claim 2, which has a cavitation area percentage of from 1.6% or more to 1.9% or less as a product having been put to said high-speed high-temperature blow forming.
